(19) United States
(12) Patent Application Publication
(10) Pub. No.: US 2003/0154407 A1
(43) Pub. Date: Aug. 14, 2003

(54) Service providing method, system and program

(76) Inventors: Hiromitsu Kato, Machida (JP); Shigetoshi Sameshima, Machida (JP); Katsumi Kawano, Kawasaki (JP); Takeshi Miyao, Hitachiohta (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/270,516

(22) Filed: Oct. 16, 2002

(30) Foreign Application Priority Data
Feb. 8, 2002 (JP) 2002-031891

(51) Int. Cl. H04L 9/00

(52) U.S. Cl. 713/201

(57) ABSTRACT

In a single-sign on system provided, being prevented from centralization of communication load and processing load onto a central system, with taking security and privacy into the consideration, an authentication portion of a field server makes check on an authentication information received from the portable terminal. A ticket issue portion issues a ticket, and then registers it in a ticket DB, as well as, transmits to the portable terminal. Receiving a permission certificate and the ticket from the portable terminal, a service provider portion provides service to the user within an area permitted by the permission certificate, while the ticket issue portion issues a new ticket to be transmitted to the portable terminal, when the ticket received is correct one. A past record inquiring portion gives an inquiry on correctness of the ticket to that field server when receiving the ticket issued by other field server.

### BACKGROUND OF THE INVENTION

The present invention relates to a movable service providing system of tracking-type, for lightening or reducing a load upon a user using services decentralized locally, and it relates to, in particular to the movable service providing system of tracking-type for enabling various services available with safety and security at different places of the public spaces, such as those within office buildings and/or station buildings, etc., for example.

Under circumferences of using services with use of information apparatuses, an importance is acknowledged, in particular, on access control, mainly including authenticating for an identification, etc. Such the authentication or authorization has been conducted through submission of a passport or the like, however under the circumferences where various services are available through a network, but distributively or extensively, a user who tries to use or access the service is requested to submit a certificate for identification, every time when she/he does so, therefore it increases the load on the user, in particular, inputting the information for the authentication.

Conventionally, a technology is already known, for eliminating such the troublesome of inputting the certification information, by limiting the submission of the certificate only one time, i.e., at the first time, for example, in Japanese Patent Laying-open No. 2001-236315 (JP-A 236315/2001) entitled “User Authorization System, User Authorization Assistance System and Recording Medium for Memorizing User Authorization Program”. This conventional art discloses that, when receiving an initiation request for an application APb after the initialization operation of an application APa, an authorization portion transfers an authorization information auth(b) to the application Apb if access control information stored in an access control information memory portion indicates an allowance for initialization. Upon receipt of the authorization information from the authorization portion, the application APb compares and checks on coincidence between the authorization information received and the authorization information auth(b) stored in the authorization information memory portion, i.e., whether they coincide with each other or not, and then it starts the operation thereof if they are verified to coincide with, as a result of that comparison.

Further, there is already known a location detecting system with using an active badge, applying therein a method for identifying a person in a seamless manner. Thus, irradiating a user ID from the active badge via infrared light, receivers provided at various positions receive the user ID, thereby detecting her/his address or location of the user. Moreover, conventionally is known a technology of providing guidance fitting to personal background and/or interests of a visitor with using such the active badge, for example, in Japanese Patent Laying-open No. Hei 11-249779 (JP-A 249779/1999) entitled “Visitor Guidance Assisting Apparatus and Method thereof”.

However, such the conventional arts mentioned above have the following problems. Namely, all requests must be made to the authentication portion, and therefore processing load upon the authentication portion increases, extremely, in a case where the users are enormously large in the number thereof, or if the service area of the application is widely distributed or spread.

Also, in a case of applying the system of such the type for seamless authentication, i.e., that irradiating the infrared ID therefrom, such as the active badge, for example, there may occur a problem that the infrared ID illegally copied or imitated will be used maliciously or improperly, by a third person. And, such the intensive or centralized system of observing the users centrally is unprofitable, in particular from a viewpoint of protection of individual privacy of the user.

### BRIEF SUMMARY OF THE INVENTION

An object is, according to the present invention, by taking security into the consideration, as well as the privacy, therefore to provide a service providing system, being capable to avoid the communication load and/or the processing load from being centralized onto a central system.

According to the present invention, for achieving such the object as was mentioned above, there is provided technology for providing service requested by a host field server of a plural number of field servers provided on a service provider side, by tracking a service receiving request from a terminal on a service user side, moving position thereof, comprising: transmitting authentication information upon basis of input information of a service user from said terminal to a first field server through wireless communication; checking correctness of said authentication information by means of said first field server, and generating a ticket mentioning a ticket information upon basis of a random number for said service user when the authentication information is correct, thereby returning the ticket to said terminal while registering thereof; transmitting the use request for service attached with a permission certificate describing a role of said service user and said ticket to said first field server; checking whether said ticket coincide with that registered by means of said first field server, providing the service to said service user within an area permitted upon basis of said permission certificate when said ticket is the correct one, and generating a new ticket in place of said ticket, thereby transmitting the new ticket to said terminal while renewing registration thereof; accessing by transmitting a newest ticket of said tickets from said terminal to the second field server, making an inquiry on correctness of the ticket to said first field server through a network by said second field server, and generating a new ticket when said ticket received is registered in said first field server, thereby returning the new ticket to said terminal while registering thereof; and providing the service required upon basis of said permission certificate and the ticket newly issued by means of said second field server.

According to the present invention, the user can receive the service continuously, but without necessity of receiving the authentication, again, every time when she/he moves her/his position, and also it is not necessary for her/him to make an inquiry to a centralized-type authentication server being physically far from, therefore it is possible to reduce the communication load, thereby to escape or avoid from centralization of the processing load onto a center of the system. Also, using a random number ticket of disposable-type makes the system tough against replayed attacking thereon, comparing to the system of the ID broadcasting type, such as using the active budge, etc. Furthermore, when conducting an access control on the basis of a past record of actions, the past record of actions is not needed be managed or supervised in centralized or intensive manner, therefore it is possible to add a restriction onto the use of service while protecting the privacy of the user thereof at the same time.

### BRIEF DESCRIPTION OF THE DRAWINGS

FIG. 1 shows the entire configuration of a tracking-type movable service providing system, according to an embodiment of the present invention;

FIG. 2 shows an example of the constituent information for a past-record certificate;

FIG. 3 shows an example of the constituent information for a permission certificate;

FIG. 4 shows a flow of processes conducted until when a service menu is displayed through a user authentication, according to the embodiment of the present invention;

FIG. 5 shows an example of the structure of a ticket DB;

FIG. 6 shows a flow of processes for providing a service responding to a request from a portable terminal, according the embodiment of the present invention;

FIG. 7 shows a flow of processes for checking whether a request for using a service is within an allowable area or not;

FIG. 8 shows an example of the structure of a publication key DB;

FIG. 9 shows an example of the structure of an access rule DB;

FIG. 10 shows a flow of processes for succeeding a fact of the user authentication from an origin of past-record, according to the embodiment of the present invention;

FIG. 11 also shows a flow of processes for succeeding the fact of user authentication, but without using the past-record, according to other embodiment of the present invention;

FIG. 12 shows an example of an input screen for inputting authentication information, in order to make an access to a field server, first;

FIG. 13 shows an example of a setting screen for setting a privacy policy therein;

FIG. 14 shows an example of a screen for inquiring and/or confirming the provision of privacy information;

FIG. 15 shows an example of a display screen of the menu service; and

FIG. 16 shows an example of a display screen of the menu service when the location thereof is moved.

### DETAILED DESCRIPTION OF PREFERRED EMBODIMENT

Hereinafter, embodiments according to the present invention will be fully explained by referring to the attached drawings.

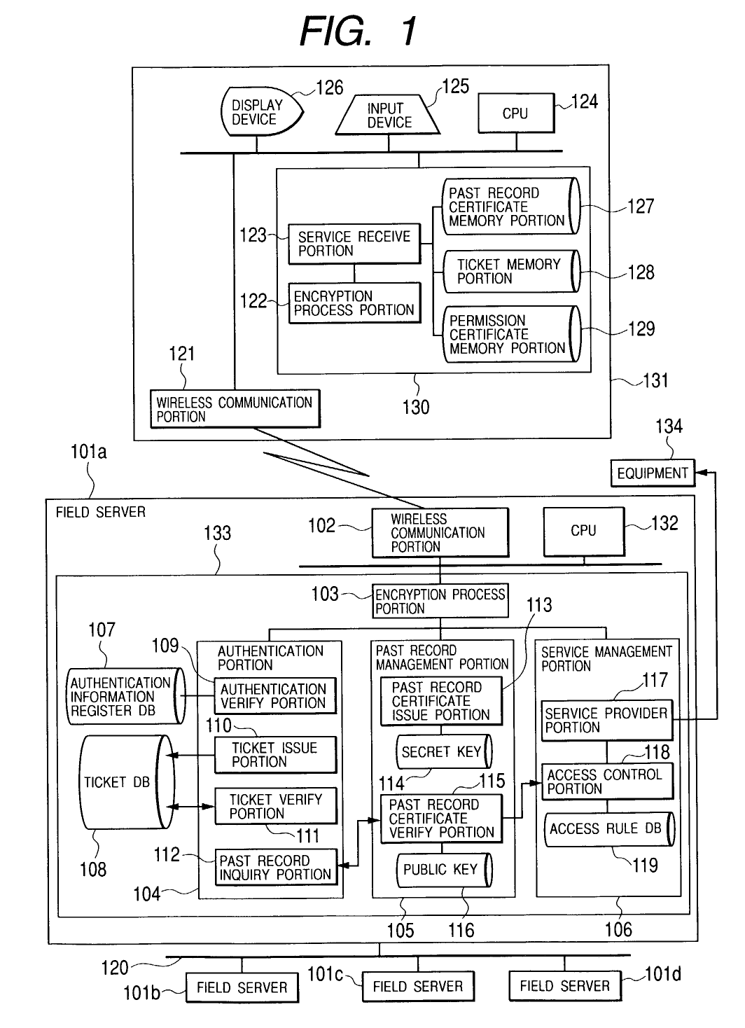

First, explanation will be given on an embodiment, in which the present invention is applied into providing of services, for example, within an office building, by referring to FIG. 1. In this FIG. 1 is shown the entire structure or configuration of the movable service providing system of tracking-type, according to the present invention. The present system comprises field servers 101 locally distributed within the office building(s), and portable terminals 131. Those field servers 101a to 101d are connected to one another through a network 120.

Each field server 101 is a calculating machine, in which program is loaded onto a memory 133 to be calculated by a CPU 132, thereby operating the program thereupon, and it makes radio or wireless communication with the portable terminals 131 through a wireless communication portion 102. For an actual practical embodiment, in more detail, the wireless LAN according to IEEE802.11, or the Blue tooth, etc., may be applicable thereto. Programs operating in the field server 101, include: an encryption process portion 103; an authentication portion 104; a past-record management portion 105; and a service management portion 106. The encryption process portion 103 encrypts messages communicated between the field server 101 and the portable terminals 131. As a standard communication means with using encryption, for example, the SSL (Secure Socket Layer) can be applied to.

The authentication portion 104 has an authentication verify portion 109, a ticket issue portion 110, a ticket verify portion 111, and an original past-record inquiry portion 112. Thus, the authentication verify portion 109 is a program for comparing the authentication information, which is transmitted from the portable terminal 131 when authenticating the user, to the information registered in the authentication information register DB 107 on the memory device, thereby making determination on whether she/he is a proper user or not. As such the authentication information are available, in a form of such as a passport or a fingerprint information, etc. The ticket issue portion 110 is a program for issuing a data generated upon the basis of random numbers, as for the ticket to issued to the user succeeding on the authentication mentioned above, and registering it into the ticket DB 108 on the memory device. The ticket verify portion 111 is provided for comparing the ticket that is submitted in the place of the authentication information, so as to check to be coincide with that registered in the ticket DB 108 or not, and thereby conducting the authentication of the user. The original past-record inquiry portion 112 is for giving an inquiry to the field server 101 playing as a host to the user just before, whether the ticket submitted is the proper one or not. Since the user moves in the location, there is no necessity that she/he is within an area or region allowed to receive the hosting from the same field server 101, therefore it is also used for succeeding the result of authentication when she/he moves to other area.

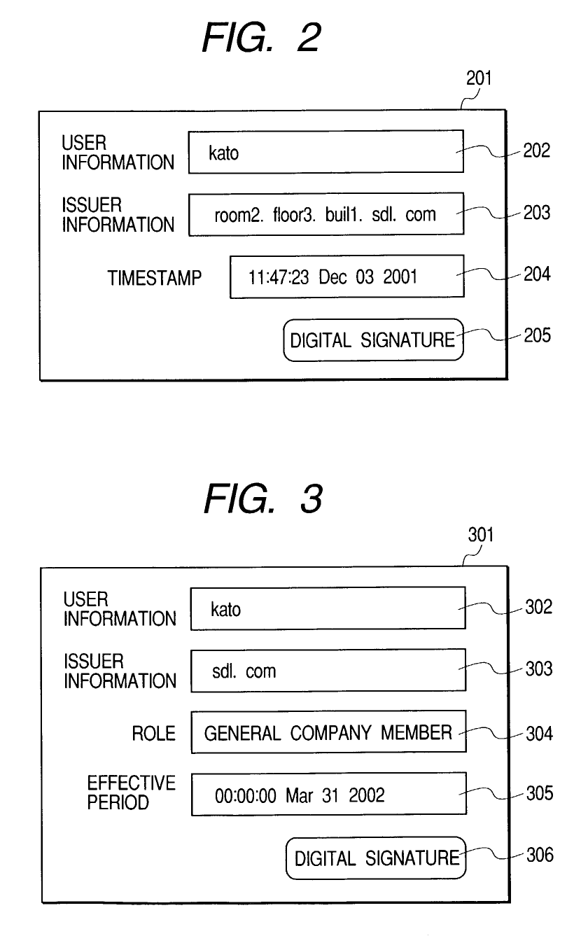

The past-record management portion 105 has a history or past-record certificate issue portion 113 and a history or past-record certificate verify portion 115. The past-record certificate issue portion 113 produces a history or past-record certificate for certifying that the user came in the area where the field server 101 plays the host with using a secret key unique to the each field server 101. An example of the past-record certificate is shown in FIG. 2. The past-record certificate 201 is made up with a user information 202, an issuer information 203, a timestamp 204, and a digital signature made for the above by means of the secret key 114. The past-record certificate verify portion 115 is for verifying justifiability of the past-record certificate 201 issued by the other servers 101b to 101d, with using a public key corresponding to the secret key used for the signature. The public key is stored in a public key DB 116.

The service management portion 106 has therein a service providing portion 117 and an access control portion 118. The service providing portion 117 produces a menu of services permitted by the access control portion 118, to be provided to the user, and also provides a service(s) which is/are requested by the user. As the services, for example, controlling of equipment 134 can be listed up, but it may include various kinds of application services through information processing. The access control portion 118 is provided for limiting the services to be provided to the user in accordance with an access rule, which is stored in the access rule DB 119.

Next, explanation will be given on the structure of the portable terminal 131. On a side of the portable terminal are provided a field server 101 and a wireless communication portion 121 for conducting wireless communication therethrough. Also, a program is loaded on a memory 130 to be calculated or executed by a CPU 124, thereby to operate thereon. The program receives an input from an input device 125, and outputs calculation results to a display device 126. The program operating on the portable terminal 131 is operated, by a service utilization portion 123 and an encryption process portion 122 for making communication with encryption. The service utilization portion 123 stores the ticket issued from the field server 101 into a ticket memory portion 128, while storing the past-record certificate 201 into the past-record certificate memory portion 127. Further, it stores a permission certificate to use or receive the service(s) into a permission certificate memory portion 129. The permission certificate is issued in advance by an organization. An example of this permission certificate is shown, for example in FIG. 3. On the permission certificate 301 are mentioned or recorded a user information 302, an issuer information 303, a role 304 permitted, and a valid period 305 of the permission, and the permission certificate is attached with a signature made by the secret key of a person giving permission or authentication to the above.

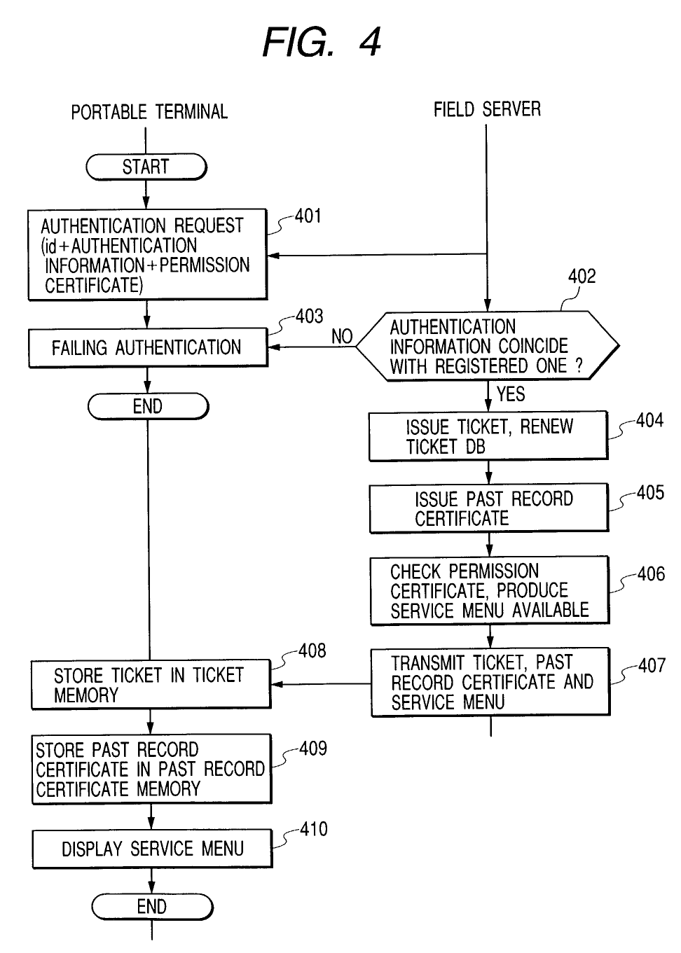

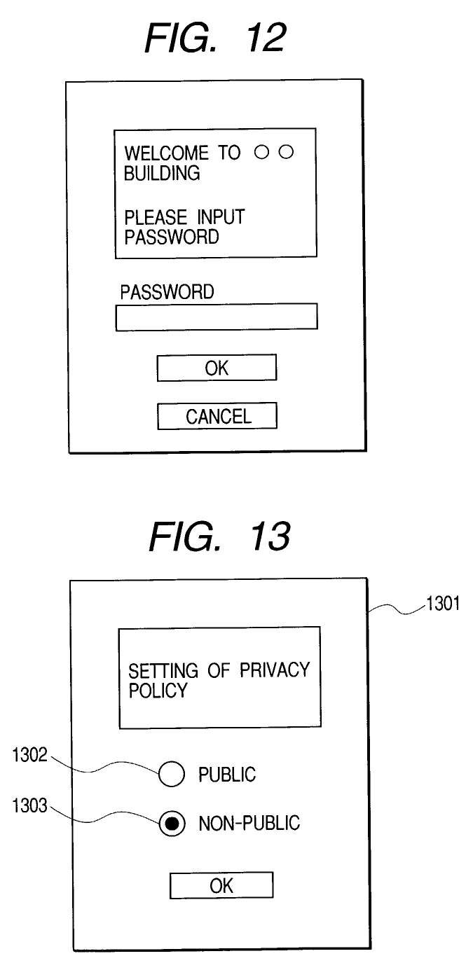

Hereinafter, explanation will be given on steps of the processing for providing the services, in more details. A flow of processes for authenticating a user, to be conducted at first, will be shown in FIG. 4. First, the portable terminal 131 transmits the authentication information obtained through the input device 125 to the field server 101, together with the permission or authentication certificate 301, thereby requesting the authentication (step 401). An example of an input screen for inputting the authentication information is shown in FIG. 12, for example, in particular when the authentication information is a passport. The authentication verify portion 109 of the field server 101 compares the authentication information submitted to the information registered in the authentication information register DB 107, thereby to determine whether they are coincident with or not (step 402). If not coincident with, it informs of failure of authentication (step 403).

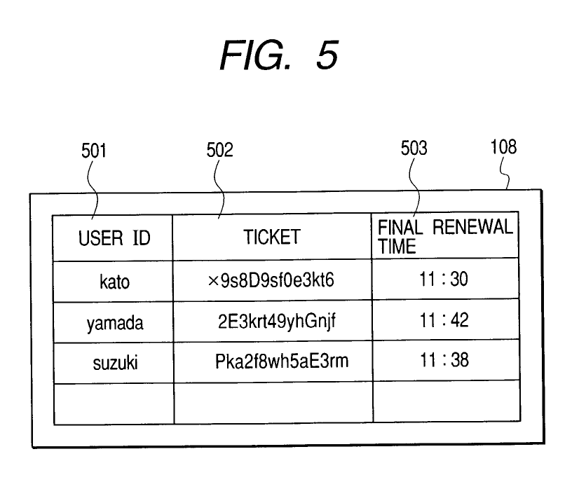

If they are coincident with, the ticket issue portion 110 produces a ticket, newly, and registers it into the ticket DB 108 (step 404). An example of the ticket DB 108 is shown, for example, in FIG. 5. Every ticket for each user includes items of a user ID 501 and a ticket 502. For example, the ticket issued to a user ID “Kato” is “X9s8D9sf0e3kt6”. A final renewal time 503 on the ticket DB 108 indicates the time when the said ticket is lastly registered or renewed. After issuing the ticket, the past-record certificate issue portion 113 issues the past-record certificate 201 showing the present time in the form of a timestamp (step 405). Next, checking the permission certificate 301, the service providing portion 117 gives an inquiry to the access control portion 118, and thereby produces a service menu available (step 406).

If the role mentioned or described on the permission certificate is “general company member”, for example, the access control portion 118 makes search on the services available to the general company member from the access rule DB 119. An example of description on the access rule DB 119 is shown in FIG. 9, for example. The access rule DB 119 is made up with a service ID 902, a service name 903, a permission condition 904, and a necessary past-record condition(s) 905. In columns of the permission condition 904 are described conditions of the roles receivable or available with the said services. Thus, for example, the services available for the “general company member” are “projector”, “lighting” and also “printer”, therefore those are listed up in the service menu. Next, the field server 101 makes up a set, together with the ticket, the past-record certificate and the service menu, in the form thereof, thereby turns it back to the portable terminal 131.

The portable terminal 131 stores the ticket into the ticket memory portion 128 (step 408), and then the past-record certificate into the past-record certificate memory portion 127 (step 409).

Next, the portable terminal 131 displays the service menu on the display device 126 (step 410). An example of the display screen of the menu is shown in FIG. 15, for example, wherein those “projector”, “lighting” and “printer” are indicated, collectively by name of a service menu 1501.

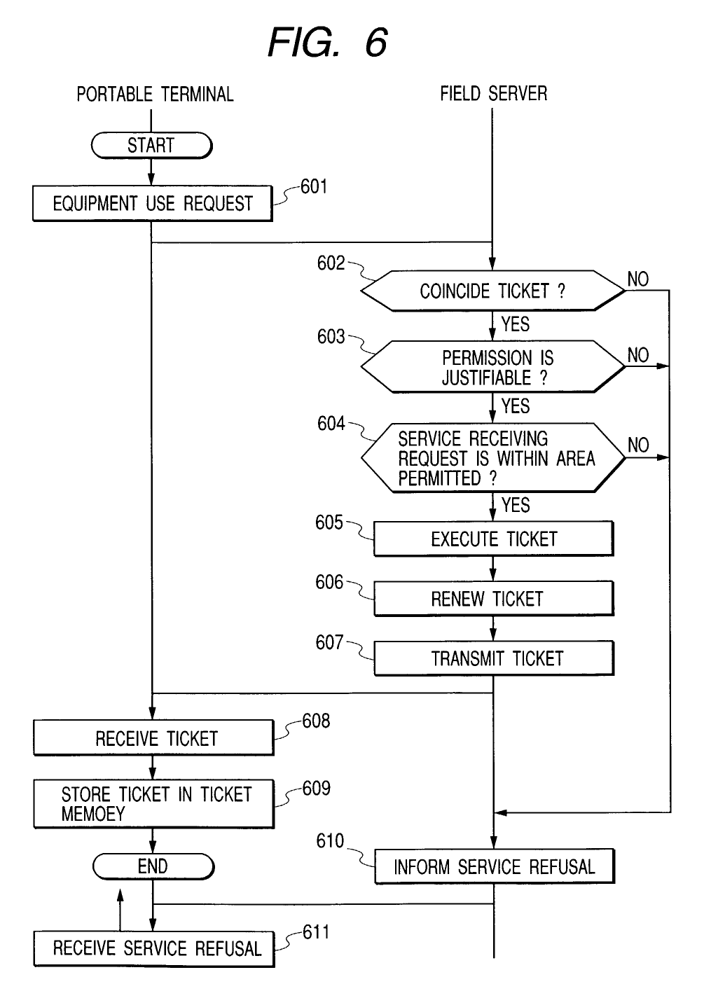

Next, a flow of processes will be shown in FIG. 6, to be conducted when the service is provided. First, a request for asking receipt of the services (hereinafter, being called by “service receiving request”) is transmitted to the field server 101, being attached with the user ID, the ticket and the permission certificate (step 601). The ticket verify portion 111 of the field server 101, first, make a check on whether the ticket corresponding to the user ID coincides with that registered in the ticket DB 108 or not (step 602). If being coincident, then next, checking is made on whether the permission certificate 301 is the authentic one or not, with using the public key of the issuer of the permission certificate, based on the digital signature 306 and the effective period 305, as well (step 603). If being the authentic one, then it is further checked on whether the service receiving request instructed is within an area or region of services allowable, by using the access control portion 118 (step 604). If it is allowed or permitted, the service providing portion 117 executes the service request which is instructed (step 605). Next, the ticket issue portion 110 renews the ticket (step 606), and returns that ticket back to the portable terminal (step 607). The ticket to be issued is a new ticket 502 with respect to that user ID 501. Then, it re-writes the ticket 502 corresponding to the said user on the ticket DB 108 into the new ticket, and further renews the final renewal time 503. In this manner, a ticket is valid or effective for only one (1) service (for each), and therefore there is no chance of re-using thereof. This prevents the ticket from being used maliciously or improperly.

The portable terminal 131 receives the ticket (step 608), and stores the ticket into the ticket memory portion 128 (step 609). For the request(s) rejected or refused in the processing of the steps 602 to 604 mentioned above, the field server 111 informs the fact of rejection or refusal of the service (step 610), while the portable terminal(s) receives the information or the notice of that rejection or refusal (step 611).

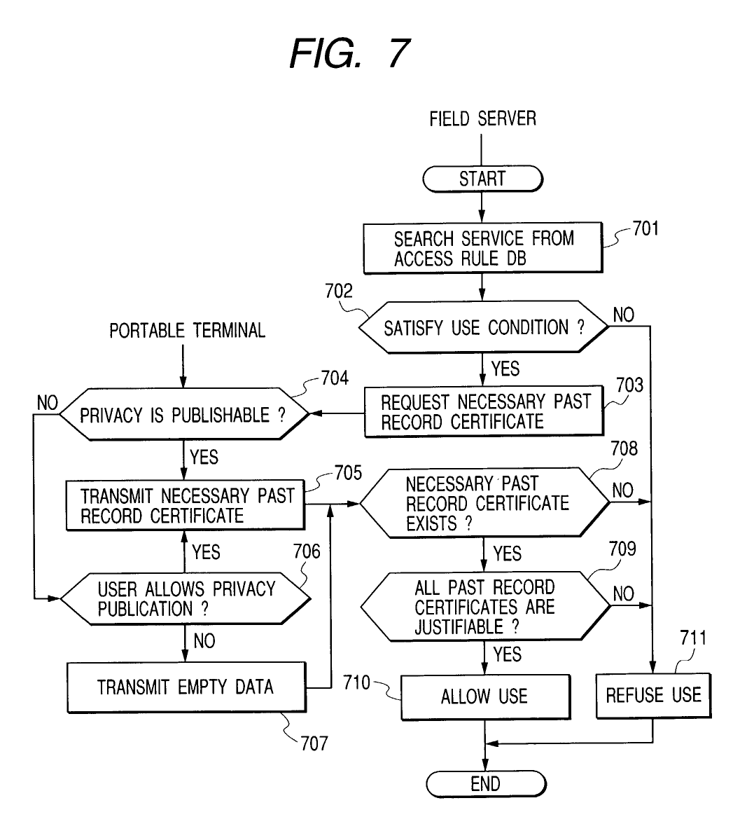

A flow of the processing for determining the permission for use of the service, in particular, in the step 604 mentioned above, will be shown in more details thereof, by referring to FIG. 7. First of all, the access control portion 118 searches out the service, being instructed or indicated, from the access rule DB 119 (step 701). Next, it determines on whether the role 304 displayed on the permission certificate 301 is satisfied with the permission condition 904 or not (step 702). For example, in the case that the role 304 is “general company member”, permission is OK if the permission condition 904 includes the “general company member” therein, or NG if not. Next, it requests the necessary past-record condition 905, corresponding to the service instructed, to the portable terminal 131 (step 703). For example, in a case where a request for using “Projector” comes in, a line 906 is searched out from the access rule DB 119, on which is described the rule of the projector service. In this line, since the necessary past-record condition is “floor1.sd1.com” and “room1.floor2.sd1.com”, therefore it is necessary to submit the past-record certificate 301 issued from those servers 101, for use of that service.

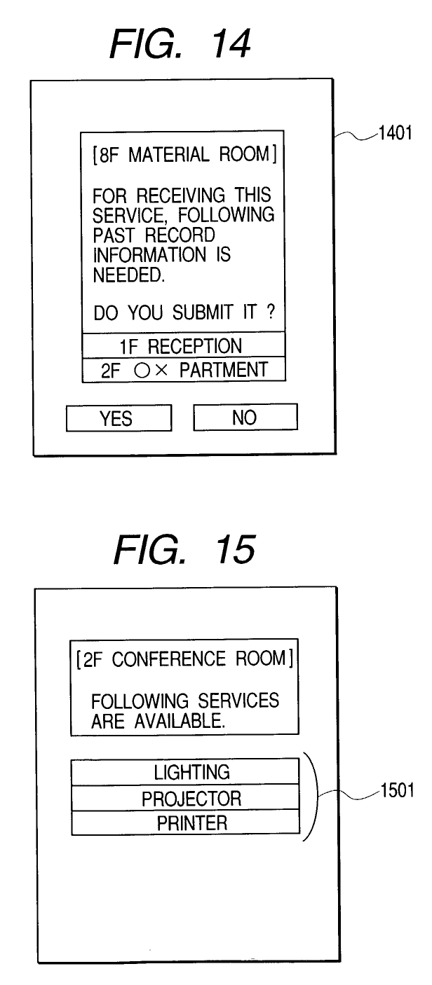

The portable terminal 131 makes determination on whether the privacy can be published or not without an inquiry thereof, but by checking the privacy policy (step 704). The privacy policy is dependent on an instruction made by the user. An example of a setting screen is shown in FIG. 13, for example for use in setup of the privacy policy. The privacy policy setup screen 1301 allows the privacy to be opened or published unconditionally if a public button 1302 therein is check marked, however it does not so if a non-public button 1303 is check marked. Herein, the “public” means, that the past-record certificate of the user will be transferred to the field servers 101. If it can be published unconditionally, the necessary past-record certificate is taken out from the past-record certificate memory portion 127 to be transmitted to the field servers 101 (step 705). If not unconditionally, an inquiry screen 1401 shown in FIG. 14 is displayed, thereby determining whether the user permits the publication of her/his privacy or not (step 706). Further, if not unconditionally, the portable terminal 131 makes an inquiry to the user on “publish/non-publish”, for each of the uses or receipt of services, through the same inquiry screen shown in FIG. 14 mentioned above. If the publication is allowed, the process proceeds to a step 705, thereby transmitting the necessary past-record certificate, on the other hand if not allowed, empty data is transmitted (step 707). Thus, when transmitting the empty data, it means that the necessary past record condition cannot be satisfied with, and as a result the user is rejected or refused to use the services.

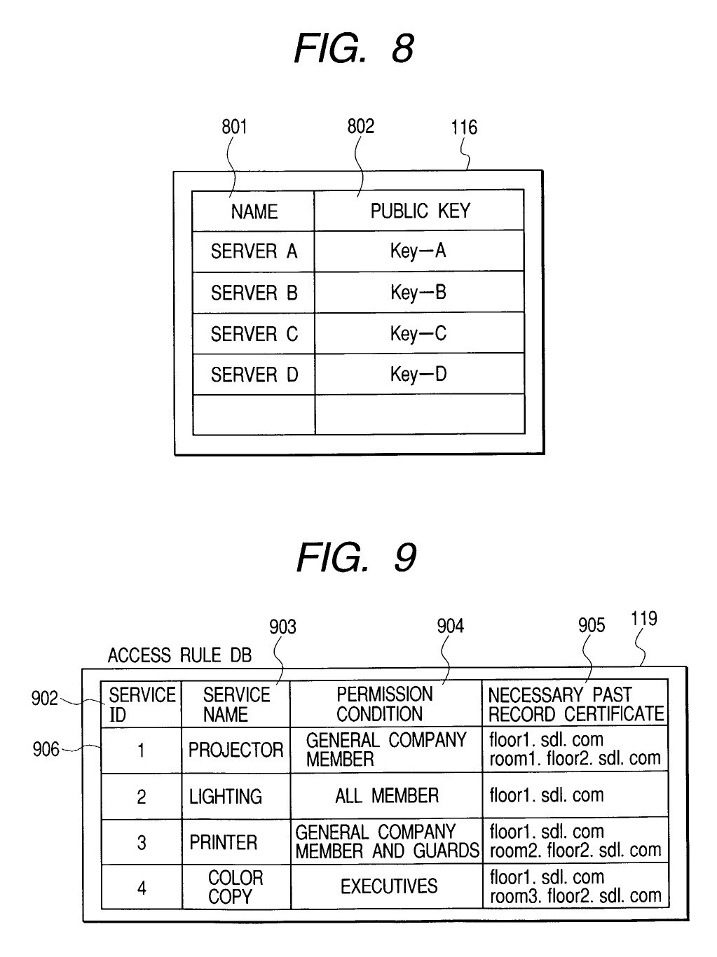

The field server 101 determines whether all past records requested are completed or not (step 708), and if all of them are completed, then a determination is made further, on whether all the past records are proper or justifiable ones or not by means of the past record certificate memory verify portion 115 (step 709). Checking whether the user information 202 of the past record certificate 201 is coincident with the said user or not, and also on whether the timestamp 204 is made within a certain time period or not (for example, within one (1) hour), thereafter the past record certificate memory verify portion 115 searches for the public key corresponding to the issuer information 203 from the publication key DB 116, thereby verifying the digital signature 205 with using the public key found out. The data structure of the public key DB 116 is shown in FIG. 8, for example. Thus, the public key DB 116 stores server names 801 and public keys 802 in a pair. If all the past record certificates are determined to be proper or justifiable, the use or receipt of service is allowed (step 710). The use or receipt of service is rejected or refused if the condition is not satisfied with, in any one of the steps 702, 708 and 709 (step 711).

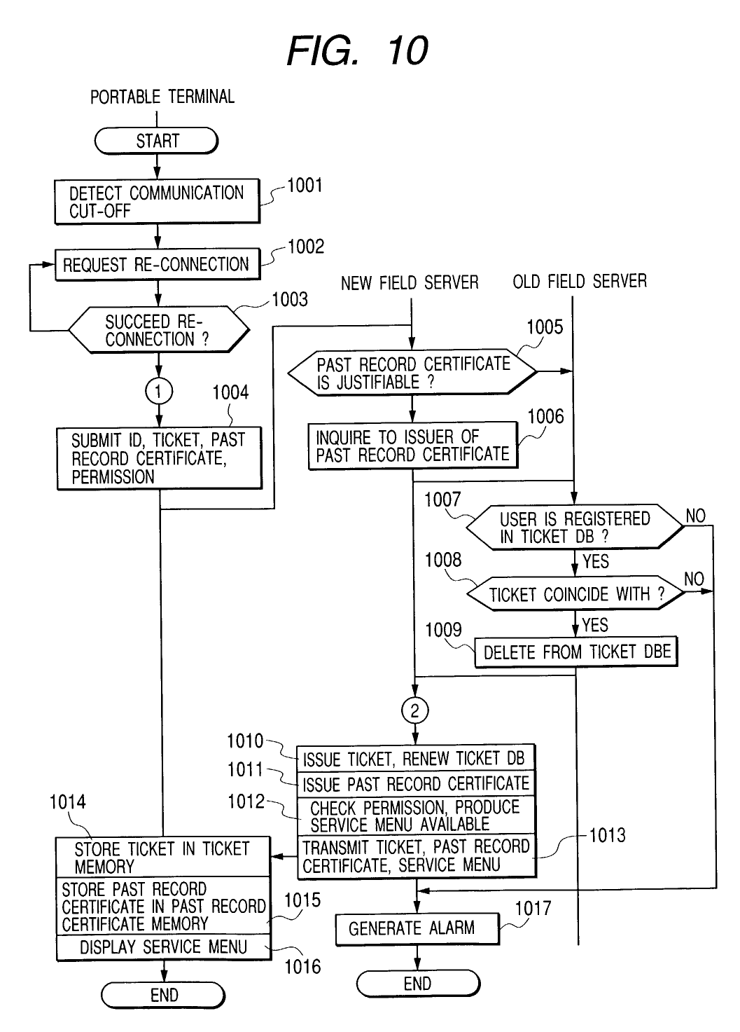

A flow for processing when the user moves her/his position is shown in FIG. 10, i.e., succeeding from the field server 101a to other field server 101b. When detecting cut-off of communication (step 1001), the wireless communication portion 121 of the portable terminal 131 makes a request for re-connection (step 1002), and then further determining whether succeeding on the re-connection or not (step 1003). If not succeeding on that re-connection, it repeats the steps 1002 and 1003, again. If succeeding, it submits the user ID, the ticket being received just before, the past record certificate being received just before, and the permission certificate to field server 101b, to a new host server (step 1004). The step 1004 is automatically carried out in the portable terminal 131, therefore bringing about no troublesome on the user, such as inputting the authentic information. Receiving the information submitted, the field server 101b verifies the justifiability of the past record certificate 201 by means of the past record certificate verify portion 115 thereof (step 1005). Herein, the verification is made on the righteousness of the digital signature 205 attached onto the past record certificate 201. In the case that the past record certificate 201 is the justifiable one, the past record inquiry portion 112 specifies a domain name of the issuer from the issuer information 203 of the past record certificate 201, thereby requiring the user ID and the ticket to the field server 101a, which is the original issuer, through the network 120 (step 1006). However, if the original one is the field server 101b, then the process jumps to a step 1010, directly.

The original field server 101a makes search on whether the user is that registered in the ticket DB or not (step 1007), and if to be the user registered therein, then it checks on whether the ticket coincide with or not (step 1008). If the ticket coincide with, it deletes the information of the said user from the ticket DB 108, ant then informs of the fact that the verification is succeeded. The reason why the field server 101a deletes the said ticket lies in, for the purpose of deleting the unnecessary ticket, upon knowing the fact that the user moves far from the host of the field server 101a, thereby escaping the system from a risk that the mechanism of producing the ticket 502 will be broken.

While, receiving the success of verification, the field server 101b issues a new ticket by means of the ticket issue portion 110 and it also renews the ticket DB 108 (step 1010), there by issuing the past record certificate by means of the past record certificate issue portion 113 thereof (step 1011). Thereafter, confirming the permission certificate submitted, and producing the service menu available, as well (step 1012), it transmits a set of the new ticket, the past record certificate and the service menu to the portable terminal 131 (step 1013).

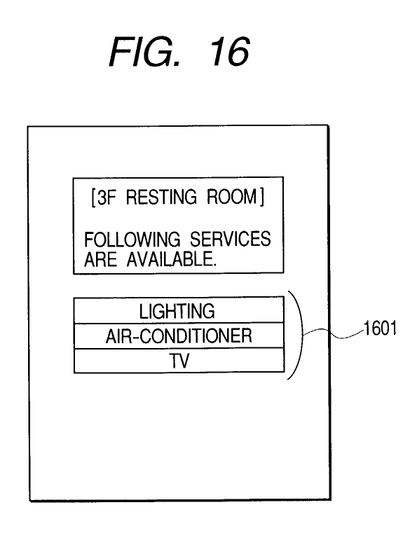

Storing the ticket into the ticket memory portion 128 (step 1014), while storing the past record certificate into the past record certificate memory portion 127 (step 1015), the portable terminal 131 displays the service menu thereon (step 1016). With such the processing as was mentioned above, the service menu 1501 shown in FIG. 15, which has been displayed up to now, is renewed automatically into a service menu 1601 shown in FIG. 16, for example.

Further, other steps 1010 to 1016 are also same to those of the steps 404 to 410. In the case when verification is failed due to the rejection or refusal in any one of the steps 1005, 1007 and 1008, the failure of verification is informed to the portable terminal 131, thereby generating an alarm thereupon (step 1017), so as to inform a manager thereof.

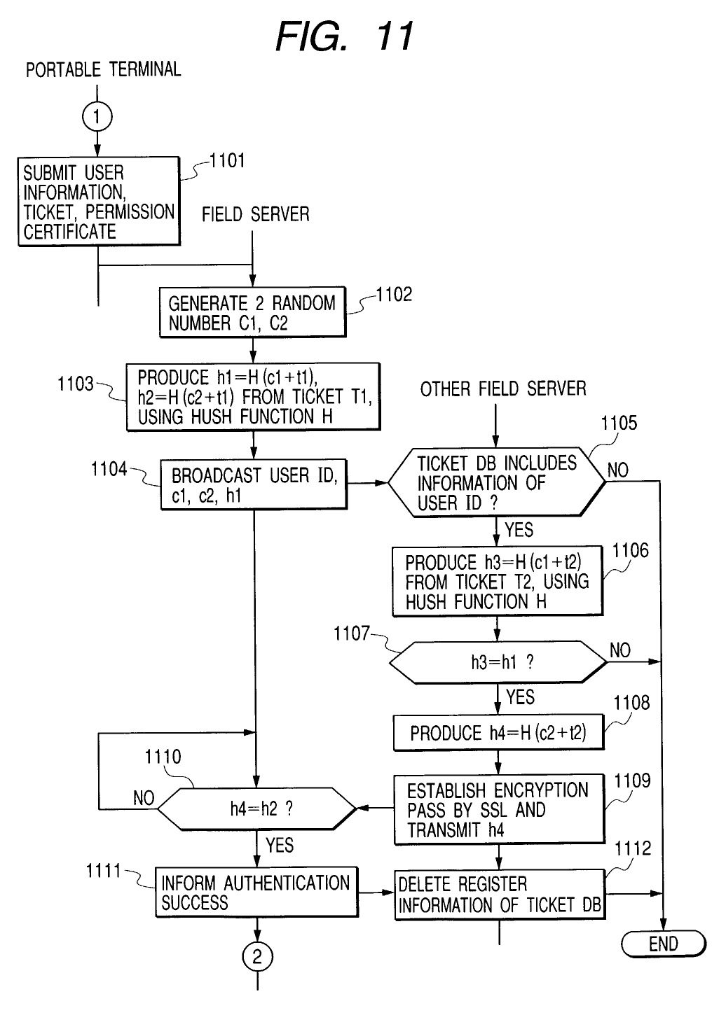

As other embodiment of the present invention, a flow of processing is shown in FIG. 11, for succeeding the fact of being verified without necessity of submission of the past record certificate, for the protection of privacy. This shown herein corresponds to the processing flow from (1) to (2) in FIG. 10 mentioned above, and also the processing before and after this is also same to that shown in FIG. 10. Thus, the portable terminal 131 submits the user ID, the ticket received just before, and also the permission certificate to the field server 101b (step 1101). Receiving those, the field server 101b generates two (2) pieces of random numbers c1 and c2 (step 1102), and thereby generates h1 and h2 indicated below, with using hash function H obtained from the ticket t1 submitted (step 1103):

h1=H(c1+t1) (Eq. 1)

h2=H(c2+t2) (Eq. 2)

As the hash function, for example, SHA-1 is known to be representative one thereof. Herein, the field server 101b broadcasts the user ID, c1, c2, and hl on the network 120 (step 1104).

Receiving this information, other field servers 101 determine whether there is the user ID or not in the ticket DB 108 thereof, corresponding thereto (step 1105). If there is not, it omits this, but if there is, it generates h3 indicated below, by taking out the ticket 502 (t2) linking to the corresponding user ID (step 1106):

h3=H(c1+t2) (Eq. 3)

Checking on whether h3 is coincident with hl (step 1107), if they are coincident, h4 indicated below is generated (step 1108):

H4=H(c2+t2) (Eq. 4)

Since t2 should not be coincident with t1 if the user receives the ticket of the field server 101a, therefore h3 should be coincident with hl in the determination of the field, server 101a. If not being coincident with, it is omitted.

Next, while verification for the client server is made by the field server 101band an SSL, a communication path is established for encryption, thereby the other field sever transmits h4 (step 1109). The field server 101b checks whether h4 received is coincident with h2 or not (step 1110), and makes a response of succeeding on verification if they are coincident with (step 1111). If not being coincident, it continues to wait it until when being delivered if they are coincident with. The field server 101 delivering h4 deletes the user information which is found out from the ticket DB 108 (step 1112).

With such the steps for the processing shown in FIG. 11 mentioned above, each field server 101 is able to make the verification thereon even if it publishes the ticket 502 to the other field servers 101.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A movable service providing method of tracking-type, for providing a service required by a host field server of a plural number of field servers provided on a service provider side, by tracking a use request for service from a terminal on a service user side moving position thereof, comprising the flowing steps of:
transmitting authentication information upon basis of input information of a service user from said terminal to a first field server through wireless communication;
checking correctness of said authentication information by means of said first field server, and generating a ticket mentioning a ticket information upon basis of a random number for said service user when the authentication information is correct, thereby returning the ticket to said terminal while registering thereof;
transmitting the use request for service attached with a permission certificate describing a role of said service user and said ticket to said first field server;
checking whether said ticket coincide with that registered by means of said first field server, providing the service to said service user within an area permitted upon basis of said permission certificate when said ticket is the correct one, and generating a new ticket in place of said ticket, thereby transmitting the new ticket to said terminal while renewing registration thereof;
accessing by transmitting a newest ticket of said tickets from said terminal to the second field server, making an inquiry on correctness of the ticket to said first field server through a network by said second field server, and generating a new ticket when said ticket received is registered in said first field server, thereby returning the new ticket to said terminal while registering thereof; and
providing the service required upon basis of said permission certificate and the ticket newly issued by means of said second field server.

2. The tracking-type movable service providing method, as described in the claim 1, further comprising the following steps of:
producing a past record certificate for certifying fact of accessing to said field server by each of said first field server and said second field server, when an access is made from said terminal, thereby returning the certificate to said terminal; and
transmitting said past record certificate to said field server in addition to said permission certificate and said ticket, thereby providing said service in a case where said past record certificate is coincident with a service condition.

3. The tracking-type movable service providing method, as described in the claim 2, further comprising the following steps of:
displaying a screen for inquiring about whether said past record certificate is published on said field server or not by said terminal, and transmitting said past record certificate to said field server when the publication is indicated by said service user.

4. The tracking-type movable service providing method, as described in the claim 1, further comprising the following steps of:
producing the first and the second random numbers by said second field server when inquiring the correctness of the ticket received to said first field server as the issuer of the ticket received by said second field server, and calculating out a first hush value obtained through a unidirectional function by combining said ticket information and said first random number and a second hush value obtained through a uni-directional function by combining said ticket information and said second random number, thereby broadcasting said first random number, said second random number and said first hush number on the network;
searching out on whether the ticket information corresponding thereto is included in the user information broadcasted or not, and calculating out a third hush value through the unidirectional, from the ticket information searched out if there is and said first random number, and then checking whether said third value and said first hush value coincide with or not, and calculating out a fourth hush value through the unidirectional, from the ticket information searched out and obtained if they coincide with, in said first field server, thereby transmitting said fourth hush value to said second field server; and
checking whether said fourth hush value is coincident with said second hush value, and considering said ticket received to be justifiable if being coincident with, by said second field server.

5. A movable service providing system of tracking-type, for providing a service required to a host field server of a plural number of field servers provided on a service provider side, by tracking a receiving request for service from a terminal on a service user side moving position thereof, wherein
said server comprising:
means for receiving authentication information from said terminal through wireless communication;
means for checking correctness of said authentication information;
means for producing a ticket mentioning ticket information based on a random number towards said service user if said authentication information is justifiable, thereby registering therein, as well as, retuning the ticket to said terminal;
means for receiving a service receiving request attached with a permission certificate mentioning a role of said service user and said ticket from said terminal;
means for checking whether said ticket is coincident with that registered or not;
means for providing the service to said service user within an area permitted upon basis of said permission certificate when said ticket is justifiable one;
means for producing a new ticket in place of said ticket and renewing the registration, as well as transmitting the new ticket to said terminal;
means for receiving the ticket issued by other field terminal from said terminal;
means for inquiring on correctness of the ticket received to said other field server, being the issuer of the received ticket, through a network; and
means for shifting into process for producing and registering the ticket to said service user, thereby returning the ticket to said terminal, when said ticket received is the correct one that is registered in said other field server, and
said terminal comprising:
means for receiving an input of said authentication information from the service user;
means for transmitting said authentication information inputted to said field server;
means for receiving said ticket received, so as to store therein;
means for transmitting the service receiving request to be attached with said permission certificate and said ticket to said field server;
means for receiving said service; and
means for transmitting a newest ticket to said field server, thereby accessing thereof.

6. The tracking-type movable service providing system, as described in the claim 5, wherein said field server further comprises means for producing a past record certificate for certificating access to said field server when being accessed from said terminal, thereby returning the certificate to said terminal, said terminal further comprises means for transmitting said past record certificate to said field server in addition to said permission certificate and said ticket, and said field server comprises means for controlling so that said service is provided when said past record certificate coincides with a condition of service requested.

7. The tracking-type movable service providing system, as described in the claim 6, wherein said terminal further comprises means for displaying a screen of inquiring on whether said past record to be published on said field server or not, and means for transmitting said past record to said field server when publication is indicated by said service user.

8. A computer process comprising:
a computer program performed on or with aid of a computer, being required to provide a service, as a host of a plural number of field servers on a service provider side, tacking a service receiving request from a moving terminal on a side of a service user, the program including:
(a) causing the computer to perform function of receiving an authentication information upon basis of input information of the service user from said terminal through wireless communication;
(b) causing the computer to perform function of checking on correctness of said authentication information;
(c) causing the computer to perform function of producing a ticket mentioning ticket information based on a random number towards said service user if said authentication information is justifiable, thereby registering therein, as well as, retuning the ticket to said terminal;
(d) causing the computer to perform function of receiving a service receiving request attached with a permission certificate mentioning a role of said service user and said ticket from said terminal;
(e) causing the computer to perform function of checking whether said ticket is coincident with that registered or not;
(f) causing the computer to perform function of providing the service to said service user within an area permitted upon basis of said permission certificate when said ticket is justifiable one;
(g) causing the computer to perform function of producing a new ticket in place of said ticket and renewing the registration, as well as transmitting the new ticket to said terminal;
(h) causing the computer to perform function of receiving the ticket issued by other field terminal from said terminal;
(i) causing the computer to perform function of inquiring on correctness of the ticket received to said other field server, being the issuer of the received ticket, through a network; and
(j) causing the computer to perform function of shifting into process for producing and registering the ticket to said service user, thereby returning the ticket to said terminal, when said ticket received is the correct one that is registered in said other field server.

9. The computer process as defined in the claim 8, wherein the program further includes:
(k) causing the computer to perform function of producing a past record certificate for certificating access to said field server when being accessed from said terminal, thereby returning the certificate to said terminal;
(l) causing the computer to perform function of transmitting said past record certificate to said field server in addition to said permission certificate and said ticket; and
(m) causing the computer to perform function of controlling so that said service is provided when said past record certificate coincides with a condition of service requested.

10. The computer process as defined in the claim 8, wherein the program further includes:
(k) causing the computer to perform function of deleting the registration of said ticket if registering the ticket that is received responding to the inquiry on the correction of the ticket from said other server.

11. A field server for providing service tracking a service receiving request from a terminal of a moving service user, comprising:
means for receiving authentication information from said terminal through wireless communication;
means for checking correctness of said authentication information;
means for producing a ticket mentioning ticket information based on a random number towards said service user if said authentication information is justifiable, thereby registering therein, as well as, retuning the ticket to said terminal;
means for receiving a service receiving request attached with a permission certificate mentioning a role of said service user and said ticket from said terminal;
means for checking whether said ticket is coincident with that registered or not;
means for providing the service to said service user within an area permitted upon basis of said permission certificate when said ticket is justifiable one;
means for producing a new ticket in place of said ticket and renewing the registration, as well as transmitting the new ticket to said terminal;
means for receiving the ticket issued by other field terminal from said terminal;
means for inquiring on correctness of the ticket received to said other field server, being the issuer of the received ticket, through a network; and
means for shifting into process for producing and registering the ticket to said service user, thereby returning the ticket to said terminal, when said ticket received is the correct one that is registered in said other field server.
